(19) United States
(12) Patent Application Publication
(10) Pub. No.: US 2020/0214321 A1
(43) Pub. Date: Jul. 9, 2020

(54) PREPARATION OF GLYCOGENIC-LIPOGENIC PRECURSORS IN THE PELLET FORM TO ENHANCE FERTILITY IN COWS DURING EARLY POSTPARTUM PHASE AND SHEEP DURING FLUSHING PHASE

(71) Applicant: ATARTURK UNIVERSITY BILIMSEL ARASTIRMA PROJELLERI BIRIMI, Eizrum (TR)

(72) Inventors: Armagan HAYIRLI, Erzurum (TR); Mehmet CENGIZ, Erzurum (TR)

(21) Appl. No.: 16/650,325

(22) PCT Filed: Nov. 2, 2018
(86) PCT No.: PCT/TR2018/050652

§ 371 Date: Mar. 24, 2020

(30) Foreign Application Priority Data
Nov. 22, 2017 (TR) 2017/18527

(51) Int. Cl. A23K 50/10; A23K 20/24; A23K 20/158

(52) U.S. Cl. CPC A23K 50/10; A23K 20/158; A23K 20/24

(57) ABSTRACT

Disclosed is a precursor used for prevention of hypocalcaemia in early lactating cows and sheep production enterprises, reduction of negative energy balance in early postpartum period and shortening this period, enhancement of pregnancy rate and enhancement of flushing effectiveness in sheep, and a method for production of the precursor in pellet form.

### THE RELATED ART

Invention relates to precursor (feed additive agent) used for prevention of hypocalcaemia in lactating cows and sheep production enterprises, reduction of negative energy balance in early postpartum period and shortening this period, enhancement of pregnancy rate and enhancement of flushing effectiveness in sheep.

The invention particularly relates to precursor (feed additive agent) providing enhancement of glycogenic—lipogenic precursor engorging appetite of cows of postpartum period and sheep of flushing period, and production method of mentioned precursors in the pellet form.

### BACKGROUND OF THE INVENTION

Postpartum period in cows is defined as the period of restoration of genital organs to pre-pregnancy status in terms of anatomic, histological and functional aspects after completion of birth, and is considerably important in respect to continuation of fertility. Factors such as fast hormonal status changing during and after pregnancy period, stress caused by birth influence cow intensively. Problem free completion of this period in normal time is essential for continuation of fertility within normal limits. Longer postpartum period causes prolonged time to resumption of ovarian activity, insemination and confirmation of pregnancy and therefore important economic losses. For that reason, physiology of postpartum period should be well known and disorders occurring post-birth should be diagnosed and treated in the shortest time.

Cows giving birth newly show difference with other cows such as healing of production organs post-birth, start of milk efficiency and negative energy balance experiencing due to body capacity unable to meet increasing needs. During this period, particularly high efficient cows are influenced the most. Extreme condition of elite lactating cows, inadequate and unbalanced feeding in dry period and early postpartum increase negative energy balance intensity observed ordinarily. Extreme negative energy balance causes extreme condition loss ad decrease in production of hormones effective in reproduction (FSH, oestrogen, LH and Progesterone) and metabolic hormones (insulin, leptin, IGF1).

Cause of hypocalcaemia (milk fever) is failure to meet high Ca need occurring upon reduction in Ca stores in calcium quantity before birth or failure in Ca absorption which occur together with lactation, and decrease in blood Ca level. It is generally seen in old and high efficient cows within first 3 days. It can be observed within 1-2 days before birth or occasionally up to 7^{th} day after birth.

Flushing in sheep is the method of adding supplementary feeding in ratios starting from 3-4 weeks before insemination and continuing until 2 weeks after, and the period before insemination is greatly important. This application aims to get maximum fertility from sheep.

In current technique use of bypass fat and propylene glycol mixture is scientifically recommended for both early postpartum period and flushing applications. However, said products are used in powder or solution form and are not consumed by animal eagerly. 400 gr bypass fat +350 gr propylene glycol should go rumen at once so as to get desired effect (insulin tropic) For that reason, powder form added into feed does not provide insulin tropic effect. Solution is taken orally and particularly constitutes serious security problems for animals and personnel in big enterprises.

Use of 120 gr NH₄Cl per animal for last 15 days before birth has been proven scientifically for prevention of hypo calcimine. However, this chemical is not consumed eagerly by animal either. For that reason, the chemical is either added into feeding or pour onto feed in order to provide consumption of it by animals. Adding into feed is not applicable for feed industrialists when taking quantitative production into account. Forgetting pouring and/or not measuring quantity are the main issues extensively encountered for pouring onto feed.

In the related art, patent application numbered TR 2014 09784 is seen. The invention is developed for use in stockbreeding sector and relates to a feed consisting of dextrose, niacin, Vitamins A, D and E and covered by by-pass fat so as to provide digestion at small intestine in order to enhance milk and insemination efficiency of particularly bovine animals.

In conclusion, disadvantages described above and inadequacy of current solutions have necessitated a development in the related art regarding precursor used in prevention of hypo calcimine in lactating cows and sheep production enterprises, reduction of intense of negative energy balance in early postpartum period, enhancement of rate of pregnancy and enhancement of flushing effectiveness in sheep.

### PURPOSE OF THE INVENTION

The present invention relates to precursor (feed additive agent) production method meeting the needs mentioned above, eliminating all disadvantages and providing some additional advantages.

Main purpose of the invention is to provide enhancement of desires of cows in postpartum period and sheep in flushing period to eat glycogenic -lipogenic precursor eating.

Purpose of the invention is to pelletise precursor in feed format and facilitate consumption by animals and help personnel and enterprise save extra workforce.

Another purpose of invention is to prevent hypo calcimine seen in lactating cows before and/or after birth.

A further purpose of the invention is to reduce intense and period of negative energy balance in early postpartum period.

Another purpose of the invention is to enhance rate of pregnancy of lactating cows.

A further purpose of the invention is to enhance flushing effectiveness in sheep.

Another purpose of invention is to offer a safe and easy consumption for animals.

A further purpose of the invention is to produce a precursor that can provide insulin tropic effect.

In order to achieve the above mentioned purposes, the invention is a feed additive agent used in lactating cows and sheep after birth period and consisting of propylene glycol, bypass fat, MgO and it is characterized in that it consists of CaCl₂, bran and molasses syrup.

In order to achieve the purposes of the invention, said feed additive agent consists of ammonium chloride to use in pre-birth period.

In order to achieve the above purposes, it is a method of producing feed additive agent in pellet form and it is characterized in that it consists of procedure steps of
a) Mixing until propylene glycol in powder form, bypass fat, CaCl₂ and MgO become homogenous,
b) Adding bran to the obtained mixture and mixing until powder-bran distribution becomes homogenous
c) Absorbing molasses syrup by mixture and making product sticky particulate form,
d) Bringing the obtained product to pellet form by pelletizing machine.

In order to achieve the purposes of the invention, in procedure step a of said feed additive agent production method, ammonium chloride is added in order to use it in pre-birth period.

The structural and characteristics features of the invention and all advantages will be understood better in detailed descriptions below, and therefore, the assessment should be made taking into account the said detailed explanations.

### DETAILED DESCRIPTION OF THE INVENTION

In this detailed description, the preferred embodiment of precursor (feed additive agent) providing enhancement of eating glycogenic-lipogenic precursor eating eagerness of cows of postpartum period and sheep of flushing period and production method of said precursor have been described in a manner not forming any restrictive effect and only for purpose of better understanding of the matter.

Invention relates to precursor used for prevention of hypocalcaemia in lactating cows and sheep production enterprises, reduction of negative energy balance in early postpartum period and shortening this period, enhancement of pregnancy rate and enhancement of flushing effectiveness in sheep, and method for production of said precursor. The most important feature of the invention is that said precursor is pelletized and put into feed format.

Hormonal profile, growth of foetus, start of birth starts dominantly during last 21st of pregnancy. Flushing application in sheep (mainly wheat feeding) starts in last 3 weeks of pregnancy and continues during initial 3 weeks of lactation (lactation phase). Similar application is conducted in insemination period too.

Fertility success starts 21 days before birth due to above mentioned reasons (dry period) and continues 30 days after birth (lactation stage). The production method disclosed under invention is capable to produce feed additive agents easy to be consumed thanks to its pellet form that can be used for cows and sheep before and after birth.

Formulation of Feed Additive Agent of the Invention:

| | By weight quantities |
|---|---|
| Content | that can be used (%) |
| Propylene glycol | 17-18 |
| Bypass fat | 27.5-28 |
| CaCl₂ | 4-5 |
| MgO | 1.5-2 |
| Bran | 43.5-44 |
| Molasses syrup | 4.5-5 |

Propylene glycol: Glycogenic preliminary agent.
Bypass fat: Lipogenic agent.
Bran: Used as hardening and shape giving agent.
MgO: Functions as buffer.
CaCl₂: Is used as hardener.
Molasses syrup: Is used as gluing agent and provides stick of active agents in bran frame.

Method for Production of Feed Additive Agent in Pellet form for use in Early Lactating Cows and Sheep Post-Lambing:
a) Propylene glycol in powder form, bypass fat, CaCl₂ and MgO are mixed in a container until they become homogenous,
b) Bran is added to the obtained mixture and mixing is continued until powder-bran distribution becomes homogenous
(Homogenization process with bran is conducted for 10 minutes)
c) Molasses syrup of fluid-semi hard form is absorbed into the mixture and the obtained product becomes sticky particulate form.
(Said absorbing process is conducted for 10 minutes)
d) The product is brought into pellet form by physical force for 5 minutes by heating occurring in pellet machine naturally.

Feed additive gent that can be used during pre-birth period of cows and sheep can be obtained by adding NH₄Cl in procedure step a of above mentioned production method.

Formulation of feed additive agent that can be used in pre-birth period of cows and sheep:

| | By weight quantities |
|---|---|
| Content | that can be used (%) |
| Propylene glycol | 10-12 |
| Bypass fat | 10-12 |
| CaCl₂ | 5-6 |
| MgO | 0.5-2 |
| Bran | 55.5-60 |
| Molasses syrup | 4-5 |
| NH₄Cl | 8-10 |

NH₄Cl: It both provides contribution to acidity of ratio and increases protein level.

During phases of production of feed additive agents to be used during post and pre-birth period of cows and sheep, It should be noticed that moisture rates of powder products are maintained and all mixing procedures are continued until mixture gains a homogenous form.

1. A feed additive agent used in lactating cows and sheep after the birth period and consisting of propylene glycol, bypass fat, MgO and it is characterized in that it comprises CaCl₂, bran and molasses syrup to be on the pellet form.

2. A feed additive agent according to claim 1, characterized in that it comprises 17-18% propylene glycol by weight, 27,5-28% bypass fat by weight 1,5-2% MgO by weight, 4-5% CaCl₂, by weight, 43,5-44% bran by weight and 4,5-5% molasses syrup by weight.

3. A feed additive agent according to claim 1, characterized in that it comprises ammonium chloride for use before the birth period.

4. A feed additive agent according to claim 3, characterized in that it consists of comprises 10-12% propylene glycol by weight, 10-12% bypass fat by weight 0.5-2% MgO by weight, 5-6% CaCl₂, by weight, 55.5-60% bran by weight, 4-5% molasses syrup by weight and 8-10% ammonium chloride by weight.

5. Method for production of feed additive agent in pellet form for use in early lactating cows and sheep post-lambing and it is characterized in that it comprises the procedure steps of:
a) mixing until propylene glycol in powder form, bypass fat, CaCl₂ and MgO become homogenous;
b) adding bran to the obtained mixture and mixing until powder-bran distribution becomes homogenous;
c) absorbing molasses syrup by mixture and making product sticky particulate form; and
d) bringing the obtained product to pellet form by pelletizing machine.

6. A method for production of feed additive agent according to claim 5, characterized in that it comprises 17-18% propylene glycol by weight, 27,5-28% bypass fat by weight 1,5-2% MgO by weight, 4-5% CaCl₂, by weight, 43,5-44% bran by weight and 4,5-5% molasses syrup by weight.

7. A method for production of feed additive agent according to claim 5, characterized in that ammonium chloride is added in procedure step a, for use before the birth period.

8. A method for production of feed additive agent according to claim 7, characterized in that it comprises 10-12% propylene glycol by weight, 10-12% bypass fat by weight 0.5-2% MgO by weight, 5-6% CaCl₂, by weight, 55.5-60% bran by weight, 4-5% molasses syrup by weight and 8-10% ammonium chloride by weight.
